(19) United States
(12) Patent Application Publication
(10) Pub. No.: US 2025/0187198 A1
(43) Pub. Date: Jun. 12, 2025

(54) Autoencoder with Non-Uniform Unrolling Recursion

(71) Applicant: Mitsubishi Electric Research Laboratories, Inc., Cambridge, MA (US)

(72) Inventors: Anoop Cherian, Belmont, MA (US); Moitreya Chatterjee, Somerville, MA (US); Ram Ramrakhya, Atlanta, GA (US)

(73) Assignee: Mitsubishi Electric Research Laboratories, Inc., Cambridge, MA (US)

(21) Appl. No.: 18/531,976

(22) Filed: Dec. 7, 2023

(51) Int. Cl. B25J 9/16; G06N 3/045

(52) U.S. Cl. CPC B25J 9/1697; G06N 3/045

(57) ABSTRACT

A non-uniform video encoder system for generating a multi-depth encoding data for a scene is provided. The non-uniform video encoder system is configured to receive a sequence of video frames of a video of the scene and transform the sequence of video frames into series input data. The series input data is analyzed to identify changes in the evolution of the scene, by partitioning the series input data into a sequence of non-uniform segments. Each segment in the sequence of non-uniform segments is encoded by an encoder of an autoencoder architecture with non-uniform unrolling recursion to produce multi-depth encoding of the series input data. To encode a current segment at a current iteration to produce a current encoding, the non-uniform unrolling recursion combines the current segment with a previous encoding produced at a previous iteration and encodes the combination with the encoder.

### TECHNOLOGICAL FIELD

The present disclosure relates generally to robot control, and more particularly to training and controlling a robot to perform a task based on hierarchical scene graph processing.

### BACKGROUND

An objective of robotics and artificial intelligence (AI) is to create robotic agents that co-habit, assist and naturally interact with humans. With developments in deep neural networks, agents or robots have been built that may autonomously navigate a realistic three-dimensional environment for solving real world tasks. As an example, the task may relate to audio-goal navigation, i.e., visual navigation to localize objects that makes sound in an environment, a vision and-language navigation (VLN), i.e., navigation to a goal location following instructions provided in natural language or exploring a visual world seeking answers to a given natural language, and so forth.

However, the robots that are deployed and operate in realistic virtual worlds may be unable to navigate reliably through such environments. To address this shortcoming, reinforcement learning (RL) policies may be trained to use the visual environment and the 3D spatial directionality of the audio (if available) to navigate.

Efficiently searching for objects-of-interest in a natural 3D environment is an important capability that autonomous embodied robotic agents must be equipped with. Some example tasks of this nature include: (i) searching for trapped people in a disaster site, (ii) searching for lost objects in a factory environment, and (iii) searching followed by picking up and placing of objects in rearrangement tasks, among others. Robots deployed to solve such tasks in the real world have learned policies (or inductive biases) to develop efficient and effective strategies for solving them. We also expect such learned policies be generalizable to new environments that may be different from the training data.

Some tasks use RGB and depth images of the scene (from the view of the agent) as inputs to the learning model to learn navigation policies (either via reinforcement learning or imitation learning), e.g., to decide where to move next to search for the object. However, such inputs (with raw pixels capturing the scene) are less accurate in learning which scene regions need to be used to produce effective navigation strategies and thus could demand huge training sets and millions of training episodes. One approach to tackle this scenario is to extract relevant semantic details from the scene and then train the agent to use only a subset of image regions, thus leading to faster training. A standard way to model the scene sparsely (while not sacrificing the semantic content) is via a scene graph representation. In this graph representation of the scene, the nodes of the graph correspond to objects in the scene produced using an object detector (that is trained to detect objects of interest in the scene), and a relationship detector that can capture the 3D spatio-semantic relationships between each node (e.g., table is “behind” the chair, etc.). Further, representing the scene as a semantic graph also allows for disentangling the pixel details and abstracting the scene at a higher semantic granularity for improving generalization.

While scene graphs seem like a useful representation, they are not advantageous for embodied setting, specifically when the embodied scene's appearance changes dramatically with each move of the agent. As a result, a scene graph for every agent move is required, causing the number of such graphs per episode to grow linearly with the number of navigation steps. This linear growth makes a quadratic increase in the number of graph edges, thus slowing down graph inference. Further, to construct the scene graph one needs to execute an object detector on the scene views, which may lead to slowing down of the decision making speed in embodied navigation.

Therefore, a computationally efficient and feasible solution is needed to circumvent these issues and provide efficient robotic agent control for different tasks.

### SUMMARY

It is an object of some embodiments to provide a solution to the problem of efficient agent navigation using a computationally efficient and feasible navigation method.

Some embodiments are based on the recognition that an artificial intelligence system, such as a system based on neural networks, is capable of learning complex patterns and relationships in visual data, allowing them to effectively construct and understand scene graphs. The choice of the specific neural network architecture and approach depends on the complexity of the task and the desired level of detail in the scene representation.

Some embodiments are based on a recognition that performance of the neural networks depends on the amount of data provided for processing. A very large and frequently changing data set poses challenges related to computational time and training efficiency of the neural networks. These challenges are further increased when dealing with series data expanding in time and/or space, such as in the visual scenes described above.

Other examples of such time-series data includes video and/or audio signals, GNSS measurements, data packet exchange, etc. Even if instead of processing raw time-series data, the features of time-series data are extracted for subsequent processing by a downstream neural network, the sheer amount of the extracted features may prohibit their joint processing due to computational power and memory constraints. To that end, many different applications process time-series data in portions, i.e., segment by segment using a so-called sliding window method. This approach fragments the data but is acceptable when the task of the downstream neural network is based on the local analysis of the data, such as generating a caption of a scene that is just a portion of a video. However, when the task is global, e.g., generating a summary or the main point of the entire video, such fragmented processing alone, may be suboptimal.

The same problem exists in applications dealing with spatial data representing complex environments. For example, reinforcement learning (RL) is an area of machine learning concerned with how intelligent agents ought to act in an environment to maximize the notion of cumulative reward. The notion of the environment differs for different applications, but for many practical applications, like robot control or drone navigation, the size of the environment makes it prohibitively large for full consideration, at once. For example, consider robotic search operations within a multi-floor building. Maintaining the entire map of the building for making decisions at each step of the control is computationally expensive for the limited resources of a search agent like a search robot.

To that end, it is an object of some embodiments to provide a system and a method for representing large amounts of data into a compact and fixed size, suitable for processing by a downstream neural network. Additionally or alternatively, it is an object of some embodiments to disclose such a system and a method that can encode incoming series data expanding in time and/or space into a fixed-sized global representation. Some embodiments address this problem with the help of an autoencoder with unrolling recursion.

An autoencoder is a type of artificial neural network used to learn efficient coding of unlabeled data (unsupervised learning). An autoencoder learns two functions: an encoding function that transforms the input data, and a decoding function that recreates the input data from the encoded representation. The autoencoder learns an efficient representation (encoding) for a set of data, typically for dimensionality reduction.

The output of the encoder, i.e. the encodings of the input data into the latent space, can be forced to be of a fixed size. The encodings in the latent space may have no physical meaning, but due to the principles of the autoencoder, that latent space preserves the original information in a manner allowing the decoder to decode it into the original space.

Some embodiments are based on the realization that the principles of the autoencoder can be extended to recursive encodings in the latent space. Specifically, the encodings in the latent space can be again encoded by the same encoder and later recursively decoded by the decoder of the autoencoder. For example, if the input data is encoded twice by an encoder of the autoencoder architecture, that twice encoded data could have the same dimension in the latent space regardless of the number of encodings and can be recursively decoded by executing the decoder of the autoencoder architecture twice.

Some embodiments are based on another realization that the recursive encodings of the autoencoder can be used by downstream neural networks even without the subsequent recursive decoding. It is recognized that this is one of the advantages of an autoencoder paradigm to encode in a way such that the encodings can be decoded to retrieve the original input. As a result, the recursive encodings preserve the information sufficient for the decoding and thus can be used by the downstream neural networks with and/or without the decoding. However, the recursive autoencoder brings little benefit for many practical applications because the recursive encodings do not necessarily make the data more compact or advantageous for subsequent processing.

However, some embodiments are based on another realization that the same rationale used for the recursive autoencoder is valid for the autoencoder with unrolling recursion in which the input to the encoder includes original (unencoded) data and the data previously encoded by the encoder. The unrolling recursion is performed by combining segments of the input stream with previously encoded encodings in the latent space and encoding the combination into the latent space and repeating the process until a termination condition is reached.

As a result, the output of the encoder includes encodings of different depths and can encode more and more new incoming data into a multi-depth encoding of the same fixed size. Moreover, the multi-depth encoding can be submitted into a downstream neural network without the recursive decoding, allowing the downstream neural network to perform the task of processing a lengthy data of unknown length by processing the multi-depth encoding of fixed length.

Additionally or alternatively, some embodiments are based on recognizing that the size or amount of the original unencoded data to be combined with previously encoded data can vary between different iterations. It is recognized that such non-uniform unrolling recursion does not break the performance guarantees of the autoencoder architecture. In addition, allowing to vary the size of the unencoded data in different encoding iterations can give each encoding an additional meaning specific and/or advantageous to the downstream application.

For example, in downstream applications related to navigation, the unencoded data in each encoding iteration can represent a space with a specific semantic meaning. Examples of such spaces include a room, a street, a town, etc. For example, in one embodiment in which the semantic space is a room and the downstream application is the navigation of a robot within a building with multiple rooms, each encoding iteration includes adding unencoded features of a room, e.g., represented as a local scene graph, to a previously encoded information indicative of features of multiple rooms in the building that have been already traversed by the robot. Doing this in such a manner allows the navigation application to rely on the extra semantic meaning during each decoding. However, different rooms can include different numbers of objects and different sizes of local scene graphs representing different objects in the different rooms. Hence, some embodiments use non-uniform unrolling recursion to capture variations of data representing different rooms.

Some embodiments are based on the recognition that using the architecture of the autoencoder described above, the scene graphs for a room at different points in time can be abstracted using a representation that is computationally feasible. Some embodiments provide a solution involving a hierarchy of scene graph representations. The hierarchy of scene graph representation is obtained using a three step method in some embodiments. The three step method comprises the following steps: (i) for every move of the agent, a pose difference of the agent (from a previous pose) is used to decide whether to construct a new local scene graph of the scene, (ii) if the pose changed significantly, then the agent computes a local scene graph, and then uses the pose to register this graph with a global scene graph by matching the overlapping objects in the new view with the objects already present in the global graph (using their 3D proximity), such registration allowing for adding of new nodes in the graph which are not present in the global scene graph. While these two steps avoid redundant nodes in the graph, the graph size can still grow dramatically when the agent explores a large area. To resolve this problem, the (iii) third step includes abstracting the global scene graph into a super-node, based on a pre-defined criterion. For example, if the number of nodes in a global scene graph is more than a threshold, then a super-node algorithm is invoked.

Some embodiments are based on a realization of another situation, when the number of steps taken by the agent reaches a threshold (i.e., a fixed sized temporal motion window of steps). Accordingly, some embodiments provide the super-node generation algorithm to be implemented as a graph neural autoencoder with unrolling recursion that takes as input a scene graph and produces a feature vector in a suitable latent space that can be decoded back to its input scene graph. This embedded feature summarizes the essential properties of the graph nodes and their semantic relationships. Post this super-node construction, for the next move of the agent, a new local scene graph is constructed, with an extra node corresponding to the super-node computed in the previous step. The super-node is fully connected to all the nodes in the local graph, and the graph construction process proceeds recursively creating super-nodes as per a predefined criteria described above.

Some embodiments are based on a realization that hierarchically abstracting the details of the scene in super-nodes without losing information (via the autoencoder) while using this information implicitly for inference enables limiting the size of the graph, thus making the inference computationally efficient and feasible.

In another example of speech recognition, different sizes of unencoded data can come from different lengths of spoken utterances, e.g., sentences. In another example of video processing, different sizes of unencoded data can come from different duration of scenes. In different embodiments, partitioning of the unencoded input data into different non-uniform semantic segments is performed based on the rules advantageous for the downstream neural network.

Accordingly one embodiment discloses a non-uniform video encoder system. The non-uniform video encoder system comprises at least one processor, and a memory having instructions stored thereon that, when executed by at least one processor, cause the non-uniform video encoder system to receive a sequence of video frames of a video of a scene. The non-uniform video encoder system is further configured to transform the sequence of video frames into a timeseries input data indicative of an evolution of the scene in time, space, or both. The timeseries input data is analyzed to identify changes in the evolution of the scene, by partitioning the timeseries input data into a sequence of non-uniform segments. Each segment in the sequence of non-uniform segments is encoded by an encoder of an autoencoder architecture with non-uniform unrolling recursion to produce multi-depth encoding of the timeseries input data. To that end, in order to encode a current segment at a current iteration to produce a current encoding, the non-uniform unrolling recursion combines the current segment with a previous encoding produced at a previous iteration and encodes the combination with the encoder. The multi-depth encoding of the series input data is output accordingly.

Another embodiment discloses a controller for controlling a robot to perform a task. The controller is configured to receive a sequence of video frames of a video of a scene. The controller is configured to transform the sequence of video frames into timeseries input data indicative of an evolution of the scene in time, space, or both. The controller is further configured to analyze the timeseries input data to identify changes in the evolution of the scene, by partitioning the series input data into a sequence of non-uniform segments. The controller is also configured to encode each segment in the sequence of non-uniform segments by an encoder of an autoencoder architecture with non-uniform unrolling recursion to produce multi-depth encoding of the timeseries input data. To encode a current segment at a current iteration to produce a current encoding, the non-uniform unrolling recursion combines the current segment with a previous encoding produced at a previous iteration and encodes the combination with the encoder. Further, the controller is configured to output the multi-depth encoding of the timeseries input data.

Yet another embodiment discloses a non-transitory computer readable storage medium embodied thereon a program executable by a processor for performing a method, the method comprising: receiving a sequence of video frames of a video of a scene; transforming the sequence of video frames into timeseries input data indicative of an evolution of the scene in time, space, or both; analyzing the timeseries input data to identify changes in the evolution of the scene, by partitioning the timeseries input data into a sequence of non-uniform segments; encoding each segment in the sequence of non-uniform segments by an encoder of an autoencoder architecture with non-uniform unrolling recursion to produce multi-depth encoding of the timeseries input data, wherein, to encode a current segment at a current iteration to produce a current encoding, the non-uniform unrolling recursion combines the current segment with a previous encoding produced at a previous iteration and encodes the combination with the encoder; and outputting the multi-depth encoding of the timeseries input data.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1 illustrates a block diagram of non-uniform video encoder system, according to some embodiments of the present disclosure.

FIG. 2 illustrates a block diagram showing operations performed for processing the sequence of frames by the non-uniform video encoder system, according to an embodiment of the present disclosure.

FIG. 3 is a block diagram showing details of components of the non-uniform video encoder system, in accordance with an example embodiment.

FIG. 4 illustrates a block diagram of a scene graph generation pipeline, in accordance with an embodiment of the present disclosure.

FIG. 5 illustrates a block diagram showing working of the non-uniform video encoder based on scene graph input, according to an embodiment of the present disclosure.

FIG. 6 illustrates a method for recursive graph generation using the SuGE model according to an embodiment of the present disclosure.

FIG. 7 illustrates a schematic showing merging of a super node with a local graph, according to an embodiment of the present disclosure.

FIG. 8 illustrates a schematic of a use case of non-uniform video encoder system for performing a downstream task, according to an embodiment of the present disclosure.

FIG. 9 illustrates a schematic diagram of a use case including an automatic speech recognition (ASR) task performed by a downstream neural network using the non-uniform video encoder system, according to an embodiment of the present disclosure.

FIG. 10 illustrates a schematic of a use case of non-uniform video encoder system for performing a downstream navigation task, according to an embodiment of the present disclosure.

FIG. 11 is a schematic illustrating a computing device for implementing the non-uniform video encoder system, according to an embodiment of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure. Contemplated are various changes that may be made in the function and arrangement of elements without departing from the spirit and scope of the subject matter disclosed as set forth in the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

It is an object of some embodiments to disclose a non-uniform video encoder system that processes series data expanding in time or space or both, in an efficient and computationally feasible manner. To that end, the non-uniform video encoder system includes an autoencoder performing non-uniform unrolling recursion to efficiently process the input data and generate an output that may be utilized by another computing system, such as a downstream neural network for performing a task. The detailed description of the non-uniform video encoder system and its various applications is provided in the following disclosure, accompanied by suitable drawings.

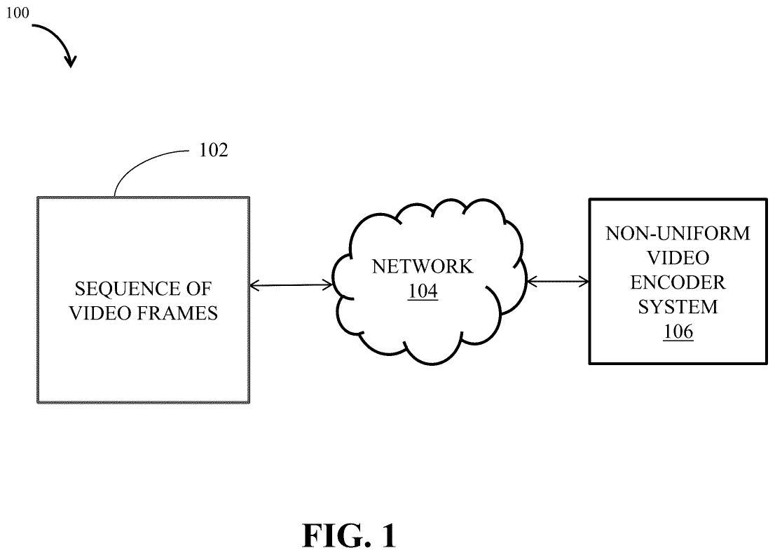

FIG. 1 shows a block diagram 100 of a non-uniform video encoder system 106 for performing a task, using non-uniform unrolling recursion. The non-uniform video encoder system 106 may be implemented as a computing system or may be embodied within a controller. To that end, the non-uniform video encoder system 106 may include at least one processor; and memory having instructions stored thereon that, when executed by the at least one processor, cause the non-uniform video encoder system 106 to perform a series of operations to enable the performance of the task.

To that end, the non-uniform video encoder system 106 receives as input a sequence of video frames 102 of a video of a scene. For example, the scene may be captured using RGB and depth images associated with an embodied navigation task. Alternately, the non-uniform video encoder system 106 data as video and/or audio signals, GNSS measurements, data packet exchange, and the like. In some examples, the scene may be related to performance of a task such as searching for trapped people in a disaster site, searching for lost objects in a factory environment, and searching followed by picking up and placing objects in rearrangement tasks, among others. The task may be performed by an agent, such as a robot, equipped with a controller that generated control commands for controlling the robot to perform the task related to the embodied navigation of the robot in the scene.

In some embodiments, the sequence of video frames 102 is transformed into series input data indicative of an evolution of the scene in time, space, or both. To that end, each frame of the sequence of video frames 102 is first extracted from the video of the scene. Further, from each frame, relevant features are extracted using learning models or a neural network or any processing algorithm configured for feature extraction. Thereafter, the extracted features are organized, such as by arranging the extracted features or pixel values from each frame in a sequential manner to create the series input data. The series input data includes a row for a specific time point (frame), and a column for a feature or pixel value.

Further, the series input data is analyzed to identify changes in the evolution of the scene, by partitioning the series input data into a sequence of non-uniform segments of data. The partitioned series input data in the form of non-uniform segments is transmitted to the non-uniform video encoder system 106. In one embodiment, the non-uniform segments are transmitted to the non-uniform video encoder system 106 over a network 104. The network 104 may be any combination of communication networks including a local area network (“LAN”) and a wide area network (“WAN”), e.g., the Internet, and the like.

Some embodiments are based on recognizing that non-uniform partitioning of the series input data add additional flexibility and adaptability into the encoding algorithm. For example, different segments of different sizes can encode different kinds of objects in the scene and/or different portions of a scene with the same semantic meaning. Allowing the partitioning of the input series data to be non-uniform enables some embodiments to perform semantically meaningful partitioning, e.g., partitioning into non-uniform segments indicative of changes in the evolution of the scene, such as moving from one room in a building to another room. For example, in some embodiments, the changes in the evolution of the scene are identified by one or a combination of: an event detected in the scene, a change in a coloration pattern in the scene, a change in captions describing the scene, a change in results of a classification of the scene, an anomaly detected in the scene, an acoustic event detected in the scene, or an event associated with a camera capturing the evolution of the scene with the sequence of the video frames.

Accordingly, the non-uniform video encoder system 106 is configured to encode each segment in the sequence of non-uniform segments by an encoder of an autoencoder architecture with non-uniform unrolling recursion to produce multi-depth encoding of the series input data. To encode a current segment at a current iteration to produce a current encoding, the non-uniform unrolling recursion combines the current segment with a previous encoding produced at a previous iteration and encodes the combination with the encoder. The resulting multi-depth encoding of the series input data is then sent as output from the non-uniform video encoder system 106. The output may further be used for further processing and applications including performing tasks related to scene awareness. For example, a downstream neural network may be used to consume the multi-depth encoding of the scene and use it to cause the task to be performed. The scene represents an environment for an agent, such as a robot, performing the task. The notion of the environment differs for different applications, but for many practical applications, like robot control or drone navigation, the size of the environment makes it prohibitively large for full consideration. For example, robotic search operations within a multi-floor building require maintaining the entire map of the building for making decisions at each step of the control, which is computationally expensive for the limited resources of a search robot.

To that end, the non-uniform video encoder system 106 is configured to provide a system and a method for representing large amounts of data into a compact and fixed size suitable for processing by the downstream neural network. Additionally or alternatively, the non-uniform video encoder system 106 is configured to encode the incoming series data expanding in time and/or space into a fixed-sized global representation. Some embodiments address this problem with the help of an autoencoder with unrolling recursion. The autoencoder thus encodes the input data in the form of sequence of video frames 102 into a latent representation by combining semantically, based on a predefined criteria associated with at least size of the input data, the input data at a current time step with an output of previous encodings of the encoder at a previous time step, to produce a compressed latent representation of the input data as an output. The compressed latent representation of the input data comprises a multi-depth encoding of the input data. The multi-depth encoding on the input data, which is essentially a time series data, typically refers to a hierarchical or multi-layered representation of the input time series data. Each layer in this encoding captures different levels of abstraction or features from the time series, starting from low-level features (e.g., simple patterns) to high-level features (e.g., complex patterns or global trends).

In the context of an auto-encoder, which is a type of neural network used for unsupervised learning and dimensionality reduction, a multi-depth encoding involves using multiple layers in the encoder part of the auto-encoder to gradually learn increasingly abstract and complex representations of the input time series. In some implementations of the auto-encoder with multi-depth encoding, the encoder comprises multiple hidden layers stacked on top of each other, such that each hidden layer learns increasingly abstract and complex features of the input data, forming a hierarchy of representations. The final hidden layer of the encoder thus gives the compressed latent representation of the input data, which is produced as the output of the non-uniform video encoder system 106. This output is then passed to the downstream neural network for further processing.

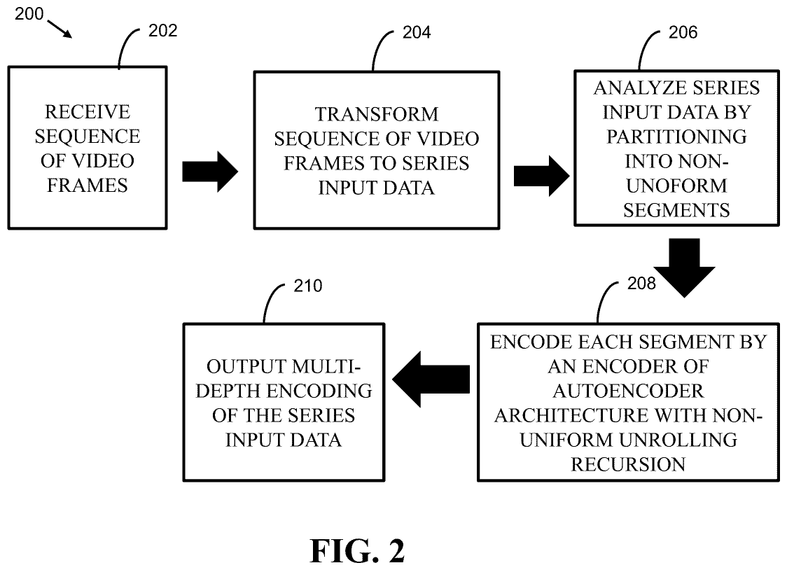

The downstream neural network is tailored for the specific type of application related to the performance of the task. For example, the task may be related to speech processing, embodied navigation, GNSS measurements, automation in manufacturing set-up and the like. A block diagram of operations performed for processing the sequence of frames 102 by the non-uniform video encoder system 106 in the manner described above is described FIG. 2.

FIG. 2 illustrates a block diagram 200 showing operations performed for processing the sequence of frames 102 by the non-uniform video encoder system 106, according to an embodiment of the present disclosure.

At 202, the sequence of video frames is received. The sequence of video frames corresponds to video of a scene in which an agent, such as a robot, is controlled to perform a task. For example, the task is embodied navigation of the robot. Embodied navigation includes navigation that can be optionally extended with interaction of the robot with an environment, which is captured as the scene, through the use of various sensors that enable perception of the environment. Examples of the various sensors include an RGB camera, a depth camera, a LIDAR unit, and the like. The video of the scene is captured through the various sensors as a sequence of video frames.

At 204, the sequence of video frames is transformed to series input data. The transformation includes such as extraction of frames from the video, extraction of features from each individual extracted frame, and organizing the extracted features sequentially to form the series input data. The series input data thus includes features expanding in time, space (such as motion features), or both, as the scene evolves.

At 206, the series input data is analyzed to identify changes in the evolution of the scene. This is done by partitioning the series input data into a sequence of non-uniform segments. The partitioning may be using a video slicing algorithm, such as a sliding window method. As a result, the series input data can be analyzed and sent for further processing in a segment-by-segment manner.

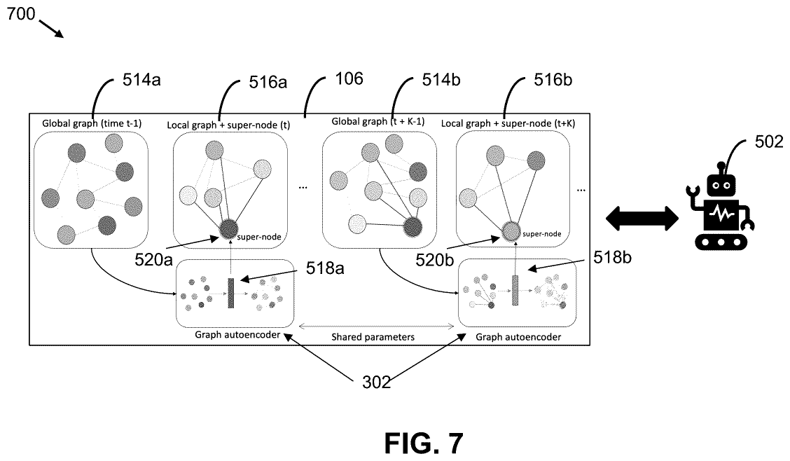

At 208, each segment is then encoded by an encoder of an autoencoder architecture with non-uniform unrolling recursion. The non-uniform unrolling recursion is an operation that produces multi-depth encoding for the series input data produced at 204 and partitioned into segments at 206. The non-uniform unrolling recursion is performed by encoding a current segment at a current iteration to produce a current encoding and then combining the current segment with a previous encoding produced at a previous iteration and encoding the combination of the current segment and the previous encoding with the encoder. This is illustrated for example, in FIG. 7. This encoding of the combination thus produces a multi-depth encoding of the series input data, with different layers formed by different combinations in the multi-depth encoding of features of the series input data.

At 210, the multi-depth encoding is output by the non-uniform video encoder system 106. The multi-depth encoding may be used by a downstream neural network for performing a task. The task may be related to video processing, audio processing, embodied navigation, manufacturing control, drone navigation and control, anomaly detection, and the like.

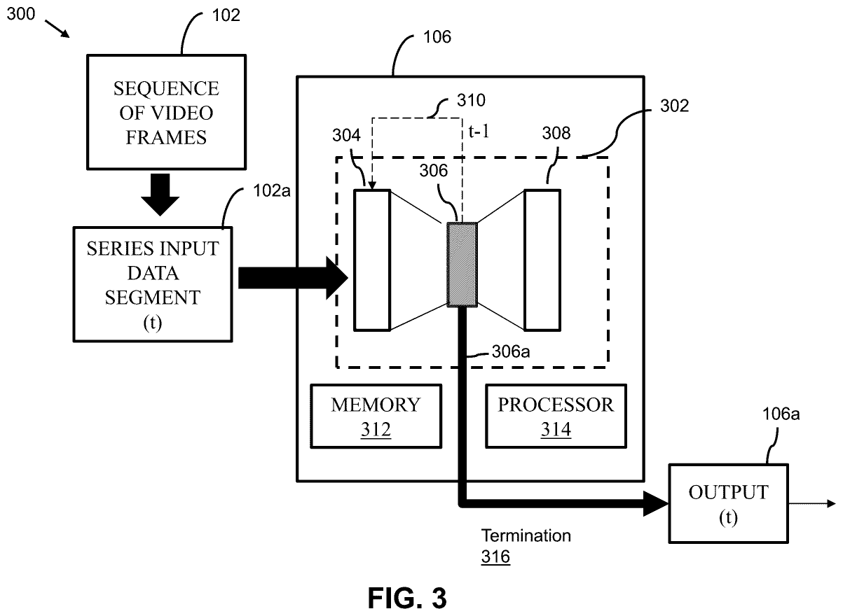

The operations 202-210 are performed by a processor, which executes computer-readable instructions that define each of the operations 202-210 in the form of a computer program, computer code, computer algorithm, and the like. The computer-readable instructions may be stored in a non-transitory computer readable storage medium in the form of a program executable by the processor to perform all the operations illustrated in the block diagram 200. In an embodiment, the processor and the memory are part of the non-uniform video encoder system 106 configured for performing non-uniform unrolling recursion, as illustrated in FIG. 3.

FIG. 3 is a block diagram 300 showing details of components of the non-uniform video encoder system 106, in accordance with an example embodiment. The non-uniform video encoder system 106 comprises an autoencoder 302 including an encoder 304 producing encodings 306 of data input to the autoencoder 302 in a latent space. The autoencoder 302 further comprises a decoder 308 to decode the encoding 306 generated by the encoder 304. During the inference stage of the autoencoder 302, the decoder module 308 may be absent and/or moved to the downstream applications.

The autoencoder 302 is a type of artificial neural network that is used to learn efficient coding of unlabeled data (unsupervised learning). The autoencoder 302 learns two functions: an encoding function for the encoder 304 that transforms the input data of the autoencoder 302, and a decoding function for the decoder 308 that recreates the input data from an encoded representation or encoding 306 produced by the encoder 304 in the latent space. The autoencoder 302 learns an efficient representation (encoding) for a set of data, typically for dimensionality reduction.

The output of the encoder 304, i.e. the encodings 306 of the input data into the latent space, can be forced to be of a fixed size. The encodings 306 in the latent space may have no physical meaning, but due to the principles of an autoencoder, that latent space preserves the original information in a manner allowing the decoder 308 to decode it into the original space of the input data. Thus, for non-uniform video encoder system 106, the input data for the autoencoder 302 comprises a segment 102a of the sequence of non-uniform segments of the input sequence of video frames 102. The segment 102a is encoded by the encoder 304 using non-uniform unrolling recursion. The non-uniform unrolling recursion includes encoding the segment 102a at a current time instance t, which is referred to as the current segment 102a for sake of brevity of explanation to produce encoding 306 at the current time instance t. Thus, the encoding 306 becomes the current encoding 306. The encoder 304 also produces a previous encoding 310 during a previous iteration of the autoencoder 302, such as at a time instance t−1. Thus, the current encoding 306 is produced by combining the current segment 102a with the previous encoding 310 and encoding this combination with the encoder 304. This process of encoding and combining may be repeated iteratively by the autoencoder 302 until a termination condition is met. When the termination condition is met, the iterative operation of the autoencoder 302 terminates 316, and a multi-depth encoding 306a is produced as an output 106a of the non-uniform video encoder system 106.

Some embodiments are based on the realization that the principles of an autoencoder can be extended to recursive encodings in the latent space. Specifically, the encodings 306 in the latent space can be again encoded by the same encoder 304 and later recursively decoded by the decoder 308 of the autoencoder 302. For example, if the current segment 102a is encoded twice by an encoder of the autoencoder architecture, that twice encoded data would have the same dimension in the latent space regardless of the number of encodings and can be recursively decoded by executing the decoder of the autoencoder architecture twice.

In an embodiment, the combination of the current segment 102a with the previous encoding 310 of the encoder 304 is done based on a predefined criteria associated with at least size of the input data. For example, the predefined criteria specifies a size limit for the input data in the form of the sequence of video frames 102, or the predefined criteria specifies a number of time steps that have elapsed since the last combination operation was performed. Thus, the combined input to the encoder 304 is then used to produce the output 106a which includes multi-depth encoding 306a of the input sequence of video frames 102.

Some embodiments are based on another realization that the recursive encodings of the autoencoder 302 can be used by downstream neural networks even without the subsequent recursive decoding. It is recognized that this is one of the advantages of an autoencoder paradigm is to encode only such that the encodings can be decoded. As a result, the recursive encodings preserve the information sufficient for the decoding and thus can be used by the downstream neural networks with and/or without the decoding.

Some embodiments are based on another realization that the same rationale used for the recursive autoencoder is valid for the autoencoder 302 with unrolling recursion in which the input to the encoder 304 includes original (unencoded) data and the data previously encoded by the encoder 304. The unrolling recursion is performed by combining the input stream with previously encoded encodings in the latent space and encoding the combination into the latent space and repeating the process until the termination condition is reached.

As a result, the output of the encoder 304 includes encodings 306 of different depths and can encode more and more new incoming data into a multi-depth encoding of the same fixed size. Moreover, the multi-depth encoding can be submitted into a downstream neural network without the recursive decoding, allowing the downstream neural network to perform the task of processing lengthy data of unknown length by processing the multi-depth encoding at the output 106a of fixed length.

In an embodiment, during different iterations of the non-uniform unrolling recursion of the autoencoder 302, the segments of different sizes are encoded. In this embodiment, it is determined that such non-uniform unrolling recursion does not break the performance guarantees of the autoencoder architecture shown in the block diagram 300. In addition, allowing to vary the size of the unencoded data in different encoding iterations provides each encoding with an additional meaning specific and/or advantageous to the downstream task to be performed.

For example, in navigation related downstream applications, the unencoded data in each encoding iteration can represent a space with a specific semantic meaning. Examples of such spaces include a room, a street, a town, etc. For example, in one embodiment in which the semantic space is a room and the downstream application is the navigation of a robot within a building with multiple rooms, each encoding iteration includes adding unencoded features of a room, e.g., represented as a local scene graph, to a previously encoded information indicative of features of multiple rooms in the building. Doing this in such a manner allows the navigation application to rely on extra semantic meaning at each decoding. However, different rooms can include different numbers of objects and different sizes of local scene graphs representing different objects in the different rooms. Hence, some embodiments use non-uniform unrolling recursion to capture variations of data representing different rooms.

In another example of speech recognition, different sizes of unencoded data can come from different lengths of spoken utterances, e.g., sentences. In another example of video processing, different sizes of unencoded data can come from different duration of scenes. In different embodiments, partitioning of the unencoded input data into different non-uniform semantic segments is performed based on the rules advantageous for the downstream neural network.

In some embodiments, an event is detected based on the input data and then partitioning of the input data into segments of different sizes is done based on the detected event. The event may be used to detect changes in the evolution of the scene in which the non-uniform video encoder system 106 operated.

In some embodiments, the evolution of the scene is identified as a change in a coloration pattern in the scene. For example, the scene may change from a brightly light surrounding to a poorly lit surrounding indicating movement of an agent, such as a robot from one room to another room in a building.

In some embodiments, the evolution of the scene is identified as a change in captions describing the scene. For example, language captions may be updated to reflect different speaker preferences.

In some embodiments, the evolution of the scene is identified as a change in results of a classification of the scene. For example, in a search and rescue operation type setting, when a trapped human is detected, the scene classification may change from search unsuccessful to search successful.

In some embodiments, the evolution of the scene is identified as detection of an anomaly in the scene. For example, in an industrial automation environment, incorrect placement of objects may be identified as an anomaly and further trigger fault detection operations.

In some embodiments, the evolution of the scene is identified as occurrence of an acoustic event in the scene. The acoustic event may be such as start of playing of music in the scene.

In some embodiments, the evolution of the scene is identified as an event detected by a camera capturing the evolution of scene with the sequence of video frames 102. For instance, for a task of: “Find a tea pot”, an agent (robot) may perceive the objects in its field of view using a camera, to determine whether the agent can already see the tea pot or not and then perhaps build abstractions such as a tea pot would be an object that would be located in the neighborhood of other objects such as oven, stove, plates, dish, etc., rather than next to a toilet or a bathtub. Thus if the agent can see objects such as microwaves or stove in its current field of view, it would perhaps explore the environment more closely, while it would perhaps only do a cursory glance if in the neighborhood of objects such as television, couch, etc. As the agent explores the neighborhood, the scene keeps evolving based on perceptions by the camera.

In an embodiment, the scene may be captured by the one or more sensors of the agent and then model the scene in the form of a scene graph representation and in that case, the autoencoder 302 is a graph encoder that operates on graph data as an input.

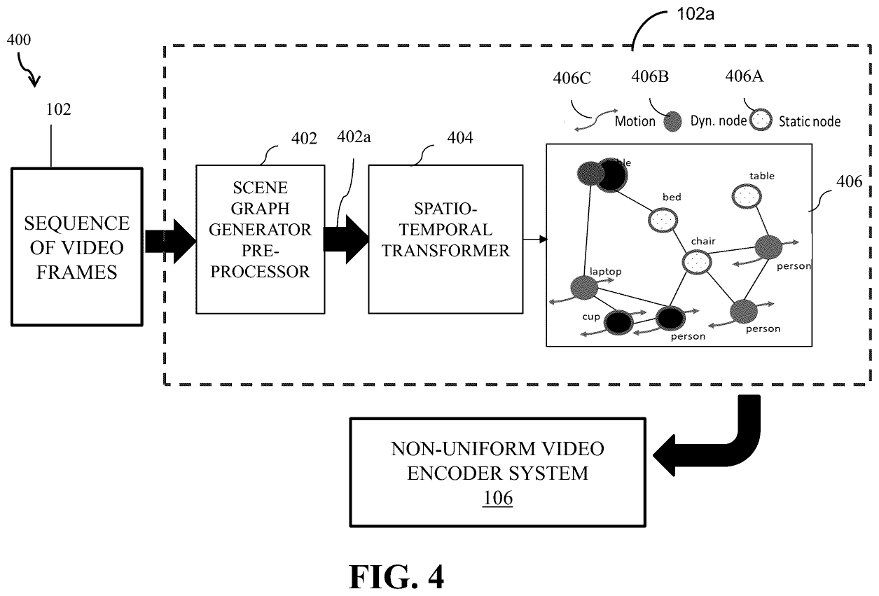

FIG. 4 illustrates a block diagram of a scene graph generation pipeline 400, in accordance with an embodiment of the present disclosure.

The scene graph representation provides a way to model the scene sparsely, while not sacrificing the semantic content of the scene. In the scene graph representation the nodes of the graph correspond to objects in the scene produced using an object detector (that is trained to detect objects of interest in the scene), and a relationship detector that can capture the 3D spatio-semantic relationships between each node (e.g., table is “behind” the chair, etc.). The scene graph representation provides for disentangling the pixel details and abstracting the scene at a higher semantic granularity thus, improving generalization. The sequence of video frames 102 of the scene processed by the non-uniform video encoder system 106 is transformed into a scene graph representation. To that end, the scene graph representation forms the series input data 102a which is received and processed by the non-uniform video encoder system 106. The sequence of video frames 102 are input to a scene graph generator 402 which provides, as an output, a spatio-temporal scene graph 406 (also interchangeably referred to hereinafter as scene graph 406) having nodes representing one or multiple objects in the scene. The current segment for the current iteration includes a portion of the spatio-temporal scene graph 406. The spatio-temporal scene graph 406 includes nodes representing one or multiple static objects, such as a static node 406A, and one or multiple dynamic objects in the scene, such as a dynamic node 406B. An appearance and a location of each of the static objects in the scene are represented by properties of a single node of the spatio-temporal scene graph 406, and each of the dynamic objects in the scene is represented by properties of multiple nodes of the spatio-temporal scene graph 406 describing an appearance, a location, and a motion of each of the dynamic objects at different instances of time.

In some embodiments, the processor 314 of the non-uniform video encoder system 106 is configured to receive the sequence of video frames 102 corresponding to a video of a scene. In an embodiment, the received sequence of video frames 102 are pre-processed by the scene graph generator pre-processor 402 to output a pre-processed sequence of video frames 402a. The pre-processed sequence of video frames 402a includes objects detected in the sequence of video frames 102 as well as depth information of the objects in the sequence of video frames 102. In some embodiments, the sequence of video frames 102 may be pre-processed using an object detection model for object detection in each of the sequence of video frames 102 and a neural network model for depth information estimation.

The pre-processed sequence of video frames 402a may then be inputted to a spatio-temporal transformer 404. The spatio-temporal transformer 404 transforms each of the pre-processed sequence of video frames 402a frames into a spatio-temporal scene graph 406 (G) of the sequence of video frames 102 to capture spatio-temporal information of the sequence of video frames 102.

The graph nodes of the spatio-temporal scene graph 406 includes one or multiple static objects of the scene, such as a bed, a chair, a table, etc. The spatio-temporal scene graph 406 also includes one or multiple dynamic objects of the scene like a person. The spatio-temporal scene graph 406 includes nodes representing the one or multiple static objects, such as the static node 406A, and nodes representing one or multiple dynamic objects in the scene, such as the dynamic node 406B. An appearance and a location of each of the static objects in the scene are represented by properties of a single node of the spatio-temporal scene graph 406, and each of the dynamic objects in the scene is represented by properties of multiple nodes of the spatio-temporal scene graph 406. The motion of each of the dynamic objects is also represented by a motion feature 406C. In some example embodiments, the motion features 406C are extracted from the dynamic graph nodes of the spatio-temporal scene graph 406 using an action recognition model, e.g., an Inflated 3D networks (I3D) action recognition model.

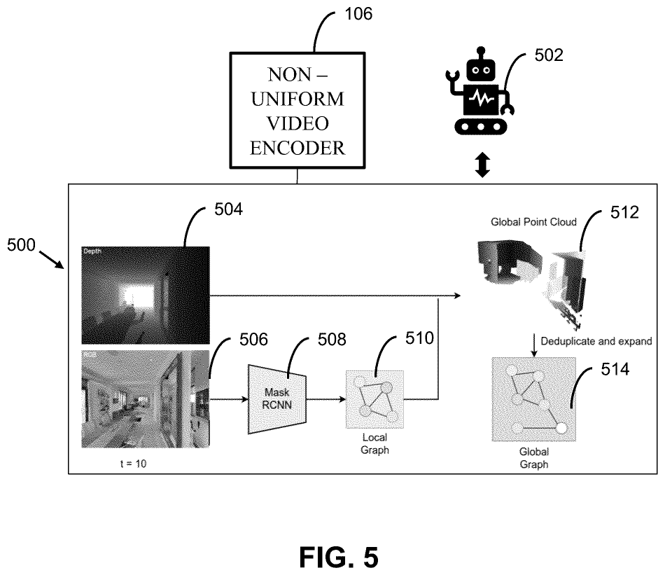

In the spatio-temporal scene graph 406 each of the graph nodes (static or dynamic) has properties that represent the corresponding object. For instance, a static graph node has properties that represent an appearance and a location of a corresponding static object. Likewise, a dynamic graph node has properties representing an appearance, a location and a motion of corresponding dynamic object at different instances of time. As a result the spatio-temporal scene graph 406 forms the series input data 102a. The series input data 102a in the form of scene graph 406 is sent to the non-uniform video encoder system 106. The non-uniform video encoder system 106 is configured to encode each segment of the scene graph at a current time instance using the encoder 304 to produce an encoding of the scene graph at the current time instance. Further, the scene graph 406 may include a previous encoding of a previous scene graph produced at a previous iteration of operation of the non-uniform video encoder system 106 forming a super node. The super node is connected with at least one node in the portion of the scene graph 406 to produce the combination encoded by the encoder 304 of the non-uniform video encoder system 106 at the current iteration. The auto-encoder 302 of the non-uniform video encoder system 106 thus becomes a graph encoder. The working of such a graph auto-encoder is further explained in conjunction with FIG. 5 below.

FIG. 5 illustrates a block diagram showing working of the non-uniform video encoder 106 based on scene graph input, according to an embodiment of the present disclosure. FIG. 5 is explained in conjunction with elements of FIG. 3. The non-uniform video encoder 106 may be coupled to a robot which is configured for capturing the sequence of video frames of a scene 500. The robot 502 is configured for performing a task, such as a navigation task, which may be embodied navigation. To that end, the robot 502 comprises various sensors to help it to perform the task. The sensors include such as an RGB camera, a depth camera, an audio sensor, a motion sensor, a LIDAR sensor, a temperature sensor, and the like.

In some embodiments, the robot 502 may include an input interface configured to receive the input data to cause motion of the robot 502. In an example, the input interface may receive the input data from the various sensors including such as imaging devices, such as camera, camcorder, etc., audio sensors, language sensors, and so forth. The input data may be used to transition a pose of the robot 502 from a start pose to a goal pose to perform a task, such as the navigation task. The input interface may be further configured to accept an end-pose modification. The end-pose modification includes at least one or combination of a new start pose of the robot 502 and a new goal pose of the robot 502. In some embodiments, the input interface is configured to receive input data indicative of visual and audio signals experienced by the robot 502 during the performance of the task. For example, the input data corresponds to multi-modal information, such as audio, video, textual, natural language, user input or validation, or the like. Such input data may include sensor-based video information received or sensed by one or more visual sensors, sensor-based audio information received or sensed by one or more audio sensors and, or a natural language instruction received or sensed by one or more language sensors. The input data may be raw measurements received from one or more sensors or any derivative of the measurements coupled with the robot 502 or installed within the robot 502, representing the audio and/or video information and signals. The input data corresponds to the sequence of video frames 102 of the scene 500.

In one embodiment, the robot 502 is a set of components, such as arms, feet, and end-tool, linked by joints. In an example, the joints may be revolutionary joints, sliding joints, or other types of joints. The collection of joints determines the degrees of freedom for the corresponding component. In an example, the arms may have five to six joints allowing for five to six degrees of freedom. In an example, the end-tool may be a parallel-jaw gripper. For example, the parallel-jaw gripper has two parallel fingers whose distance can be adjusted relative to one another. Many other end-tools may be used instead, for example, an end-tool having a welding tip. The joints may be adjusted to achieve desired configurations for the components. A desired configuration may relate to a desired position in Euclidean space, or desired values in joint space. The joints may also be commanded in the temporal domain to achieve a desired (angular) velocity and/or an (angular) acceleration. The joints may have embedded sensors, which may report a corresponding state of the joint. The reported state may be, for example, a value of an angle, a value of current, a value of velocity, a value of torque, a value of acceleration, or any combination thereof. The reported collection of joint states is referred to as the state.

The robot 502 may have a number of interfaces connecting the robot 502 with other systems and devices, such as to a controller for controlling the robot 502. For example, the robot 502 is connected, through a bus, to the one or more sensors to receive the new start pose and the goal pose via the input interface. Additionally or alternatively, in some implementations, the robot 502 includes a human machine interface (HMI) that connects a processor to a keyboard and pointing device, wherein the pointing device may include a mouse, trackball, touchpad, joystick, pointing stick, stylus, or touchscreen, among others. In some embodiments, the robot 502 may include a motor or a plurality of motors configured to move the joints to change the motion of the arms and/or the feet according to a command produced according to a control policy. Additionally, the robot 502 includes the controller configured to execute control commands for controlling the robot 502 to perform the task. For example, the controller is configured to operate the motor to change the placement of the arms and/or feet according to a control policy for commanding the robot 502 to navigate and reach an object or location of interest as part of a task description.

It may be noted that references to a robot, without the classifications “physical”, “real”, or “real-world”, may mean a physical agent or a physical robot, or a robot simulator which aims to faithfully simulate the behavior of the physical agent or the physical robot. A robot simulator is a program consisting of a collection of algorithms based on mathematical formulas to simulate a real-world robot's kinematics and dynamics. In the preferred embodiment the robot simulator also simulates the controller. The robot simulator may generate data for 2D or 3D visualization of the robot 502.

The robot 502 may also include the processor configured to execute stored instructions, as well as a memory that stores instructions that are executable by the processor. The processor may be a single core processor, a multi-core processor, a computing cluster, or any number of other configurations.

The memory may include random access memory (RAM), read only memory (ROM), flash memory, or any other suitable memory systems. The processor may be connected through the bus to one or more input interfaces and the other devices. In an embodiment, the memory is embodied within the controller and may additionally store the non-uniform video encoder system 106 including the autoencoder 302. The memory may additionally store program module or code for implementing a navigation system. The code may be used to implement functions of a neural network configured to generate a command for controlling the robot to perform the navigation, based on an output received from the non-uniform video encoder system 106. The output of the non-uniform video encoder system 106 is in the form of the multi-depth encoding 106a corresponding to the series input data of the scene 500 captured by the robot 502.

The robot 502 may also include a storage device adapted to store different modules storing executable instructions for the processor. The storage device may also store a self-exploration program for producing training data indicative of a space of the environment 500 within which the robot 502 may have to navigate. The storage device may be implemented using a hard drive, an optical drive, a thumb drive, an array of drives, or any combinations thereof. The processor of the robot 502 is configured to determine a control law for controlling the plurality of motors to move the arms and/or the feet according to a control policy and execute the self-exploration program that explores the environment by controlling the motor(s) according to the learned control policy.

The robot 502 may be configured to perform the task, such as a navigation task for navigation of the robot 502 from the initial state of the robot 502 to a target state (such as a room in a building) by following a trajectory. The trajectory may be broken down into various sub-trajectories, representing various interactions of the robot 502.

For example, the robot 502 may be given the task of searching for objects-of-interest in a natural 3D environment 500 or the environment 500 may be an embodied environment 500 that provides a virtual representation of the natural 3D environment. The robot 502 may be configured to learn policies (or inductive biases) to develop efficient and effective strategies for solving them. Also these policies may be generalizable to new environments that may be different from the training data that the controller of the robot 502 was trained on. The environment 500 is thus represented using RGB and depth images of a scene (from the view of the robot 502) as inputs to the learning model to learn navigation policies (either via reinforcement learning or imitation learning), e.g., to decide where to move next to search for the object. However, visually guided object goal navigation

presents a two-fold challenge: (i) detecting objects of interest accurately, within the field of view of the robot; and (ii) reasoning about where in the space the robot 502 currently is. However, such inputs (with raw pixels capturing the scene) pose a challenge in learning which scene regions need to be used to produce effective navigation strategies and thus could demand huge training sets and millions of training episodes.

Based on this realization, the non-uniform video encoder system 106 coupled to the robot 502 extracts relevant semantic details from the scene, such as the environment 500 (hereinafter the scene is interchangeable referred to as the scene 500), and then training the robot 502 to use only a subset of image regions, thus leading to faster training. The scene 502 is modeled sparsely via a scene graph representation, built using the scene graph generation pipeline 400 shown in FIG. 4. To that end, for every consecutive move of the robot 502, the series input data 102a is produced. The robot 502 captures an RGB image 506 of the scene 500 and a depth image 504 of the scene 500 at a current segment of the sequence of video frames 102. The RGB image 506 is provided to a Mask region based convolutional neural network (RCNN) module 508 to generate a local scene graph 510. The depth image 504 is used to generate a global point cloud 512 for the scene 500.

For this, the robot 502 constructs the 3D local scene graph 310 using objects in the scene 500 as the graph nodes and the spatial relationships between the nodes as the graph edges. This local graph 510 is then registered with a 3D global scene graph 514 via computing a spatial proximity of the local graph nodes and edges with that in thus-far constructed global graph 514. Two nodes are considered the same if their semantic labels match, as well as their segmentation masks of their 3D point clouds overlap (Mask RCNN) and their approximate spatial neighborhoods are similar. Nodes in the local graph 510 that satisfy the criteria above are merged with those in the global scene graph 514, while those that do not satisfy the criteria are inserted into the global graph 514 with edges connecting to their approximate 3D neighborhood. This process thus allows avoiding redundancy in the graph construction.

For example, given a sequence of temporally evolving local scene graphs, such as the local graph 510, one per embodied video frame, denoted by G^{l}= [symbol] G₁^{l},G₂^{l}, . . . , G_{T}^{l} [symbol] , where the local graph from a video frame at time step t is given by Gₜ^{l}=(Vₜ, εₜ, [symbol] ₜ) with vertices Vₜ={v₁^{t},v₂^{t}, . . . , vₙ^{t}} edges εₜ={eᵤᵥ^{t}}_{(u,v)∈V}_{ₜ}_{XV}_{ₜ} and [symbol] ₜ={Xᵥ^{t}}_{v∈V}_{ₜ} where Xᵥ is the neural feature associated with a vertex v.

The non-uniform video encoder system 106 is configured to register a sequence of local graphs G^{l} into a temporally evolving global scene graph G^{g}, such as the global graph 514, (ii) if a global graph satisfies a criteria for compaction, then compress the global graph into a super-node using the (graph) autoencoder 302 that embeds the entire global graph into a super-node Euclidean graph embedding (EGE) and associating each super-node with an attribute identifying it as a special node, (iii) incorporate the super-node feature into the subsequent evolution of the local and the global scene graphs, and recursively encoding the graph (with super-nodes) into super-nodes, repeating the process, and (iv) using the super-nodes for avoiding future computations along previously visited spatial regions, and thus improving computational efficiency and storage needs of the non-uniform video encoder system 106.

### Local Scene Graph Construction (510)

The robot 502 is equipped with an RGB camera and a depth camera, and it has access to the position and pose information of the agent at all times. Assuming I represents an RGB image frame, such as the RGB image 506, and D is its corresponding depth image, such as the depth image 504, and let p∈ [symbol] is the camera pose with respect to the global frame. In order to construct the local scene graph, that is the local graph 510, a MaskRCNN pre-trained model, the mask RCNN module 508, that takes as input I and produces a tuple {(l, b, X, conf)} where b is the bounding box of a detection, X is its feature vector, 1 is the object label, conf represents the confidence of the detection. Only those confident detections that have conf>η, for some threshold ηare considered. These tuples form the nodes V of the local scene graph G^{l} for the frame at a given time step.

In order to construct the edges E of the graph G^{l}, spatial proximity criterion is used. Specifically, for two nodes u and v, suppose lᵤ and lᵥ represent a representation of the location of nodes u and v, respectively. For example, l_{w} could be the 3D location of the centroid of the bounding box corresponding to node w (for example, for a small chair node) or it could also abstractly represent the point cloud corresponding to a large wall node. Given two such locations lᵤ and lᵥ, an edge eᵤᵥ between the two nodes u and v is formed in the local scene graph if dist(lᵤ-lᵥ)<ζ, where dist is a suitable distance and a given threshold ζ. For example, if 3D centroid locations of the nodes for L is used, then dist could just be the euclidean distance, however if it is a point cloud, then chamfer distance is used. Computing the chamfer distance could be expensive, when the nodes have a large set of points, e.g., a wall node or a floor node. Also in such large nodes, it may not be reasonable to use the centroids for L. In order to provide computationally cheaper non-uniform video encoder system 106, the point cloud for a pre-specified number of points may be computed, and then only these points are used for computing the Chamfer distance. Thus, using the nodes and edges defined above, the local graph 510 is generated.

Registering Local Graphs into Global Graphs (514)

When the robot 502 agent moves in a 3D space, there is a high likelihood that the RGBD frames (lₜ₋₁, Dₜ₋₁) and (lₜ, Dₜ) at time steps t−1 and t, respectively, could have significant overlaps, and thus the objects detections in these frames could be varied views of the same set of object(s). These frames could be registered (using the available camera poses p) and merge the two local scene graphs to make a more compact 3D scene graph. To this end, a global scene graph G^{g}, such as the global graph 514, could be initialized using the local scene graph from the beginning of a navigation trajectory. Suppose Gₜ₋₁^{g} is the global graph constructed thus far and Gₜ^{l} is the local graph at time step t. Then, if pₜ is the camera pose at frame or segment t, then the location of each of the nodes V of graph Gₜ^{l} could be transformed into the global frame as: lᵤ′=plᵤ, where lᵤ is either a 4×1 homogeneous vector (if we use centroids for u or 4×r matrix if we used a point cloud with r points), and p is a 3×4 projection matrix including the camera parameters.

Now that the local graph is in the coordinate frame of the global graph, the two graphs can be merged if they overlap. To achieve this, for a node vₗ∈V^{g} in the local graph 510, and if v_{g}∈V^{g} is a node in the global graph 514, then a criteria is defined as:

$$criteria = ( i ) \& ( ii ) \& ( iii ) , where \qquad ( 4 )$$

$$\begin{matrix}( i ) & \\ label ( {v}_{i} ) == label ( {v}_{g} ) & ( 5 )\end{matrix}$$

$$\begin{matrix}( ii ) & \\ dist ( {l}_{v} - {l}_{{v}_{g}} ) \leq δ & ( 6 )\end{matrix}$$

$$\begin{matrix}( iii ) & \\ ( {v}_{i} ) ∼ ( {v}_{g} ) , & ( 7 )\end{matrix}$$

where [symbol] (u) defines the neighbor set of node u, label(u) is the class label of node u, and l(u) is the 3D location of node u. Using an approximate similarity of the neighborhood, where this approximate neighborhood is defined as a non-null intersection of node pairs. That is, suppose,
Sᵤ^{l}:={(u, v)|v∈ [symbol] (u)} be the set of all pairs of node u with its neighbor nodes, and if Sᵤ^{g} be the set for a vertex in the global graph, then, the criteria will be satisfied if |Sᵤ^{l}∩Sᵤ^{g}|>η, that is, there is a non-zero intersection of the neighborhood.

If two nodes vₗ and v_{g} are from the local graph 510 and the global graph 514 respectively, then vₗ will be merged with v_{g}, and the feature

$${X}_{{v}_{g}} ← λ {X}_{{v}_{g}} + ( 1 - λ ) {X}_{{v}_{l}} , \qquad ( 8 )$$

for some λ∈(0, 1) (i.e., apply a soft update and merge of the features of the two nodes). Further, the neighbors list of node v_{g} is expanded with the non-merged (i.e., non-redundant) neighbors of vₗ. Specifically, for a node vₗ that does not satisfy the above criteria in (4), then the node will be added as a new node to graph G^{g}, with its edges connecting to other new nodes that cannot be merged with the nodes in G^{g} or edges to nodes in G^{g} that are merged from Gₗ. Hereinafter, Gₜ^{g} represents the global graph at time step t obtained by merging Gₜ₋₁^{g} with local graph G^{l}.

The generation of the local graph 510 and the global graph 514 may be done as part of the scene graph generation pipeline 400 shown in FIG. 4. The local graph 510 and the global graph 514 at a time step t form the series input data 102a of a current segment of a current iteration of operation of the non-uniform video encoder system 106. The series input data is then processed by the autoencoder 302.

### Super Node Generation Using Auto-Encoder 302

Some embodiments are based on a realization that global scene graphs are computationally expensive to process because the size of such graphs grows quickly as more objects are detected in the scene.

To that end, the non-uniform video encoder system 106 is configured to provide an efficient processing of the global graph 514 using the autoencoder 302 by encoding the global graph 514 corresponding to each segment in the sequence of non-uniform segments of the series input data 102a by the encoder 304 of the autoencoder 302 with non-uniform unrolling recursion to produce multi-depth encoding of the series input data 102a. The encoder 304 produces the encodings 306 of the series input data 102a in the form of the global scene graph 514. The encodings 306 include an embedding of the global graph 514 in the form of a euclidean vector. This embedding is associated as a feature vector to a super-node. The super-node is a special node that embeds within it an abstraction of a scene graph. Mathematically, a super node is denoted as v^{s} and is produced by an operator S: [symbol] → [symbol] , where v^{s}=S( [symbol] ).

In an embodiment, S is a graph neural network which is trained through backpropagation end-to-end with the downstream task. In another embodiment, S is a supernode graph embedding (SuGE) pre-trained model executing a SuGE algorithm and trained separately for a self-supervised task, and not trained end-to-end with the downstream task. To that end, the encoder 304 includes the SuGE algorithm for producing the encodings 306 in the form of the supernode v^{s} for the global graph 514 ( [symbol] ). Thus, the autoencoder 302 becomes a graph autoencoder taking a scene graph [symbol] as input and producing a super node v^{s} as output. The supernode v^{s} is a graph embedding produced by the autoencoder 302 (parameterized by θ).

To that end, the encoder 304 of the autoencoder 302 is characterized by an encoding function E: [symbol] → [symbol] for the encoder 304 and a decoding function D: [symbol] → [symbol] for the decoder 308. Some embodiments are based on a realization that a graph has features for every node, as well as a structure with potentially irregular neighborhoods—captured by the edges via an adjacency matrix.

To that end, the SuGE model provides a two-stage end-to-end encoding/decoding approach for the autoencoder 302: (i) in the first stage, the node feature Xᵥ for every node v is encoded using an encoder f into a latent feature zᵥ using the adjacency matrix using a graph convolutional network, and thus for the entire set of nodes, a set of latents is given as: Z={zᵥ}_{v∈vg}, and (ii) a set encoder g is used to produce the latent feature vector y.

Assuming f⁻¹ and g⁻¹ are the decoders, and let E=g∘f and D=f⁻¹∘g⁻¹, and θ is the set of all learnable parameters in the SuGE model, then learning the parameters of the model is given by defined as:

$$ℓ ( {G}^{g} ; E , D ) = {‖ X - \hat{X} π ‖}_{2}^{2} + {λ}_{1} {‖ A - \hat{A} π ‖}_{b} + {λ}_{2} {‖ n - h ( y ) ‖}_{2}^{2} , \qquad ( 10 )$$

$$π = arg {min}_{\{ γ ∈ 𝒫 ( n ) \}} {‖ Z - \hat{Z} γ ‖}_{W} \qquad ( 11 )$$

$${z}_{v} = f ( {X}_{v} \vert A ) ; ∀ v ∈ V \qquad ( 12 )$$

$$y = g ( Z , A ) , \qquad ( 13 )$$

$$\hat{Z} = {g}^{- 1} ( y , \hat{n} ) , \qquad ( 14 )$$

$$\hat{A} = σ ( \hat{Z} {\hat{Z}}^{T} ) , \qquad ( 15 )$$

$${\hat{X}}_{v} = {f}^{- 1} ( {\hat{z}}_{v} ) , \qquad ( 16 )$$

$$\hat{n} = h ( y ) \qquad ( 17 )$$

where it is assumed f and f⁻¹ are modules operating on the graph node features, while in (12), f is a graph convolutional network (GCN) taking as input the node features and the adjacency matrix, to produce latent k dimensional features Zᵥ∈ [symbol] for each node, where k<d. As we use a graph convolution network for f, each latent node feature is expected to also encode the information from its neighbors. Next, these latent features are encoded into a single feature embedding using the encoder g—which is a set encoder treating the latent feature matrix Z (with each zᵥ as a column of Z) as a set (ignoring the edge connections) and encoding it into a vector y∈ [symbol] in (13), which is the super node graph embedding (SuGE) for the graph.

In order to ensure that this auto-encoder 302 model encodes all the useful information in the graph correctly—i.e., to ensure that y indeed encodes all the information about the graph [symbol] —the loss in (10) is proposed. The key challenge with the encoding in (13) is that the graph structure and the node embeddings are all mixed up in this latent space of y, and that needs to be recovered. However, when decoding y to the set \hat{Z} (as in (14)), it is perhaps unclear how this can be done, as the order in which the encoding was done could be lost when decoding the vector to a set. To this end, first y is decoded into a matrix Z with an arbitrary order of its columns. As a vector is decoded into a set, the decoder must also need to know how many elements are going to be in the decoded set. For example, if g⁻¹ is an LSTM, it needs to be known how many times the recurrences of g⁻¹ should be executed. To this end, g⁻¹ is supplied with an estimate n of the number of nodes, i.e., n decoded using the function h(y) in (17). Next, an alignment between the items decoded in \hat{Z} and the items encoded in Z is obtained, which is described in (11) by solving an optimal transport problem using the Wasserstein distance ∥.∥_{W}, where π corresponds to a permutation matrix γ in the space of all n×n permutations [symbol] (n) capturing the alignment. Using these inputs, the loss in (10) is implemented. Specifically, in the first term in (10), the decoded feature matrix \hat{X} is minimized against the original features X. In the second term, the decoded adjacency matrix produced using (15) is aligned (recall that we had assumed the latent features z also encodes the neighborhood details of the node, and we assume that this neighborhood can be revealed by taking the correlations between the latent embeddings between the nodes as in (15) using a sigmoid) against the original adjacency using the alignment π through a binary compatibility loss ∥.∥_{b}, e. g., binary cross entropy.

In the third term in (10), the number of nodes in the graph is embedded correctly in the SuGE embedding y. When using a large set of graphs, that share the same encoders and decoders described above, the autoencoder 302 model described above learns to produce vectorial SuGE embeddings for any global graph that can be decoded faithfully to their original graphs.

In an embodiment, the auto-encoder 302 including the SuGE model is trained using data associated with several embodied navigation trajectories although it could equally work with any other sequences of local scene graphs, e.g., video scene graphs), each with a temporal evolution of scene graphs. The SuGE model is invoked recursively for encoding the graphs at times using the SuGE encoder. Next, the final embeddings are used to decode using the SuGE decoder to produce the super node features as well as the global graphs that were encoded.

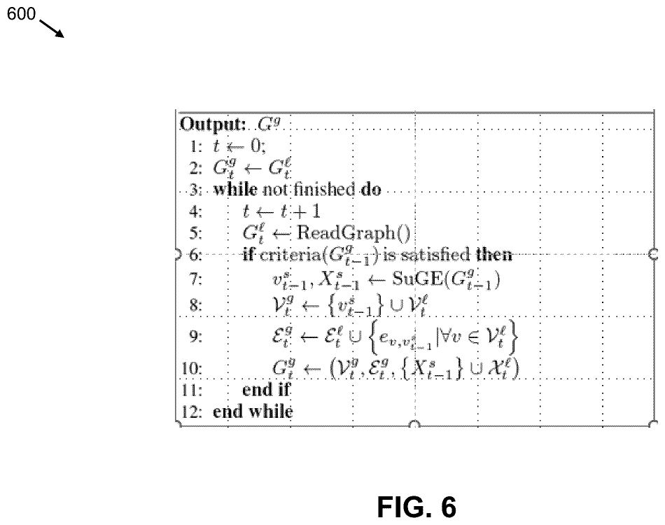

An example of a recursive graph generation method using the SuGE model implemented by the autoencoder 302 model described above, to perform the non-uniform unrolling recursion to encode the series input data in the form of the global graph 514 ( [symbol] ) into the v^{s} super node corresponding to the multi-depth encoding of the series input data is illustrated in FIG. 6.

FIG. 6 illustrates a method 600 for recursive graph generation using the SuGE model described in FIG. 5. FIG. 6 is explained in conjunction with elements from FIG. 3 and FIG. 5. The method 600 is agnostic to a downstream task. The method 600 includes one or more operations. The operations are associated with hierarchically decomposing data of a scene graph. The operations of the method 600 are described in the following description.

The operations of the method 600 include, at step 1, initiating the method 600 at current time instance t. At step 2, a local scene graph [symbol] at time instance t is assigned as the global scene graph [symbol] at the same time instance t. The local scene graph [symbol] may be the local scene graph 510 shown in FIG. 5. The global scene graph [symbol] may be the global scene graph 514 shown in FIG. 5.

At step 3, an iterative processing of steps 4-10 is initiated. The time instance is incremented at step 4, and at step 5, the local scene graph at the previous time instance, [symbol] , is accessed (such as from the memory of the non-uniform video encoder system 106). Reading the local scene graph [symbol] comprises running the object detectors on the RGB frame 506 of the scene 500 and using the depth maps or the depth images 504 to create the graph edges. At this point, at step 6, if the previously created global scene graph Gₜ₋₁^{g}, such as the global graph 514, satisfies some properties of reduction (e.g., the number of nodes is more than a threshold), then forward pass of the SuGE model executed by the autoencoder 302 for generation of supernode graph embeddings is invoked.

Further, using the SuGE model, at step 7, the super node vₜ₋₁^{s} and its feature Xₜ₋₁^{s}, is produced. Steps 8 and 9 include defining the vertices and edges of a new global graph Gₜ^{g}. Next, at step 10, a new global graph Gₜ^{g}, with nodes V^{g} given by the union of the super-node v^{s} with the vertex set V^{l} from the local graph at step t and edges obtained by the union of the edges in E^{l} with a new set of edges between all nodes in V^{l} and the super-node vₜ₋₁^{s}. Once the super-node vₜ₋₁^{s} has been created, it needs to be merged with a local graph.

FIG. 7 illustrates a schematic 700 showing merging of a super node with a local graph, according to an embodiment of the present disclosure. While the method 600 sets the foundations for building super nodes using the recursive

scene graph (RSG) algorithm corresponding to the method 600, merging the local graph from a previously visited location with the RSG is required. In an example, at a current time step is t′ when the robot 502 arrives near to a super node vₜ₋₁^{s} that was created at a previous time step t−1 (in Step 7 of method 500 the criteria for creating a super node is checked. Such as when the number of nodes, denoted n, in the graph grows larger than a threshold ηₙ. Suppose the agent recalls this super node, for example, the robot 502 maintains a list of the spatial locations of all super nodes, and it selects the closest super node to its current location if there is one such node present within a predefined radius. Further, in an embodiment, a SuGE decoder to reproduce the scene graph associated with vₜ₋₁^{s} is used. This scene graph is denoted as [symbol] =( [symbol] , \hat{ε}ₜ₋₁^{g}). The current local graph may be denoted as [symbol] =( [symbol] , ε_{t′}^{l}). Further, features X is captured within the nodes of the respective graphs. To merge the two graphs [symbol] and [symbol] some pre-defined criteria are considered. These include, in an example, four cases: (i) there is no overlap between the decoded graph and local graph, i.e., [symbol] ∩ [symbol] =ϕ, (ii) there is a partial overlap between the decoded graph and the local graph [symbol] ∩ [symbol] ≠ϕ, (iii) the local graph is a sub-graph of the decoded graph [symbol] ⊃ [symbol] and (iv) the decoded graph is a sub-graph of the local graph, [symbol] ⊂ [symbol] .

In some implementations, the merge rules for each of these four conditions is described as:
[symbol] ∩ [symbol] =ϕ, When there is no overlap between [symbol] and [symbol] , local scene graph at time t′−1, i.e., [symbol] , is merged with the current scene graph [symbol] in the global coordinate space as described previously in conjunction with FIG. 5, to produce a new global graph [symbol]
[symbol] ∩ [symbol] =ϕ, When some nodes of the decoded nodes in [symbol] overlap with the nodes in the local graph [symbol] , then merge the nodes in [symbol] with overlapping nodes in [symbol] , and the supernode vₜ₋₁^{s} is updated with new set of features [symbol] ⊃ [symbol] In this case, nothing needs to be done as the current local graph [symbol] is already accounted for in [symbol]
[symbol] ⊂ [symbol] In this case, [symbol] \ [symbol] is considered as the new local scene graph and the method 600 is executed

In some embodiments, the super-nodes are stored as a (neural) linked list of neural embeddings, while also having a hashed access to nearest nodes where the hash function is the spatial location of the agent.

This process of merging and executing method 600 is shown in FIG. 7. For a time step t−1, if the number of global graph nodes are more than a threshold or K time steps have been passed, then a graph autoencoder module, such as the autoencoder 302 with unrolling recursion, is invoked. This module takes in a current global graph 514a and produces an encoding in the form of a feature embedding 518a for a super-node 520a that summarizes the global graph 514a at the current time step, time t−1. This super-node 520a is then integrated or merged with to a local scene graph 516a at time step t via fully connected edges to the nodes in this local graph, using any of the merging conditions (i)-(iv). The global graph construction process then continues as before, and at time t+K−1, for a global graph 514b, another feature 518b is constructed by the same graph encoder of the autoencoder 302, producing a super-node 520b that is integrated with a local graph 516b at time t+K. The process is continued recursively constructing super-nodes.

The super-nodes are used to store data of the scene in a computationally efficient manner. The super-nodes are produced by the autoencoder 302 as multi-depth encoding of the series input data 102a. The multi-depth encoding is then used in performing downstream tasks.

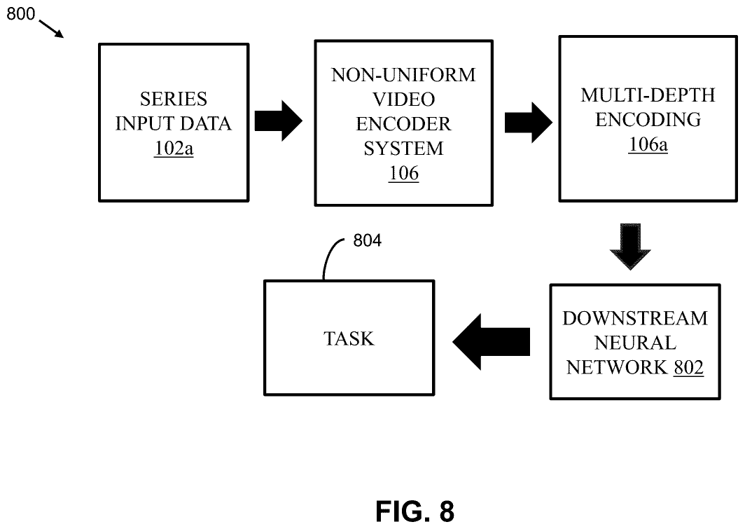

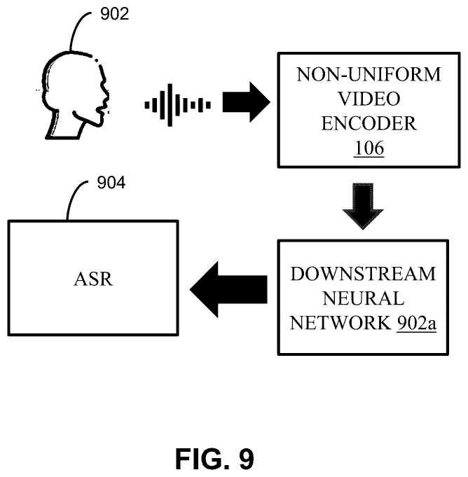

FIG. 8 illustrates a schematic 800 of a use case of non-uniform video encoder system 106 for performing a downstream task 804. The series input data 102a is provided to the non-uniform video encoder system 106 which produces the multi-depth encoding 106a using the auto-encoder 302. The multi-depth encoding 106a is transmitted to a downstream neural network 802 for performing the task 804. To that end, the downstream neural network 802 outputs a command for controlling the robot 502 to perform the task 804. The task may be an automatic speech recognition (ASR) task, as shown next in FIG. 9.

FIG. 9 illustrates a schematic diagram 900 of a use case including an automatic speech recognition (ASR) task 904 performed by a downstream neural network 902a using the non-uniform video encoder system 106. The non-uniform video encoder system 106 receives speech data 902 as the input data 102. For example, the speech data 902 includes speech utterances having multiple sentences, and an event may be an end of a sentence. The end of sentence may be detected by using a stop action. At the detection of the event, the speech data 902 may be partitioned into segments of input data and passed to the non-uniform video encoder system 106. The non-uniform video encoder system 106 may then generate multi-depth encoding of the speech data by summarizing multiple sentences, and then use these multi-depth encodings to perform ASR 904 task using the downstream neural network 902a. In an example, the downstream neural network 902a may be a caption decoder to provide captions to different speech utterances in different scenes of the input data 902. In the caption decoding task, the end of a scene capturing a segment of the audio and video frames is detected based on one or a combination of an end of a current caption and beginning of a next caption.

In another example, the ASR task 904 may be speech transcription task. In this manner, non-uniform video encoder system 106 may be used for efficient data processing in a wide variety of applications, like efficient scene navigation, efficient speech processing, efficient GNSS measurement data processing and the like. In an embodiment, the application is a navigation task as shown in FIG. 8.

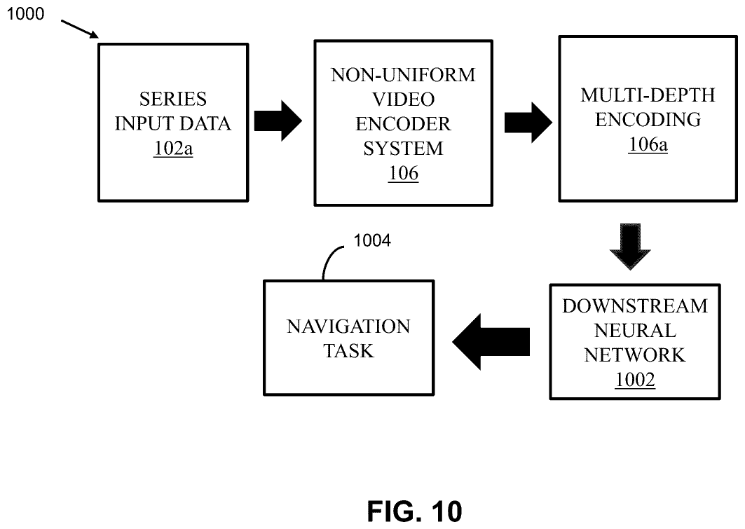

FIG. 10 illustrates a schematic 1000 of a use case of non-uniform video encoder system 106 for performing a downstream navigation task 1004. The series input data 102a is provided to the non-uniform video encoder system 106 which produces the multi-depth encoding 106a using the auto-encoder 302. The multi-depth encoding 106a is transmitted to a downstream neural network 1002 for performing the task navigation 1004. To that end, the downstream neural network 1004 outputs a command for controlling the robot 502 to navigate in an environment. The environment may be a building and the robot 502 may navigate different rooms, floors, sections etc. of the building.

The non-uniform video encoder system 106 may be embodied as a computing device in various ways such as a controller, a processor executing stored instructions, a dedicated computing device and the like.

In an embodiment, the non-uniform video encoder system 106 a transformer neural network model for extracting graph features from the nodes of the scene graph based on series input data 102a.

In an embodiment, the non-uniform video encoder system 106 comprises a recurrent neural network (RNN) when there is only a single node in a global graph and super-nodes are computed at every time step. The latent output of the RNN forms the super node embeddings that can be decoded to the inputs, as in a sequence to sequence model.

In an embodiment, other relationships between the nodes apart from spatial proximities are used to generate the local and global scene graphs. Such relationships may include for example, semantic relations such as in front of, next to, and the like, or actions between object nodes, e.g., boy plays with a bat where the relation between boy and bat is plays with. Any such equivalent relationship may be used in the non-uniform video encoder system 106, without deviating from the scope of the present disclosure.

The non-uniform video encoder system 106 may be used to perform a variety of downstream tasks such as achieving graph compression for a variety of tasks, including (i) embodied navigation for efficiently solving tasks related to scene navigation (ii) audio tasks such as localizing an object producing a particular sound, (iii) data abstraction tasks, and the like.

In an embodiment, the multi-depth encoding produced at the output 106a of the non-uniform video encoder system 106 is used to produce a recursive scene graph (RSG) as a representation of the scene in a robot's memory, that can be used to decide the next moves of the robot. Given the structure of RSG, the size of the representation is fixed and at the same time, the robot may recursively decode the navigated scene to, for example, efficiently search for the goal.

In an embodiment, the non-uniform video encoder system 106 is used for encoding video scene graphs.

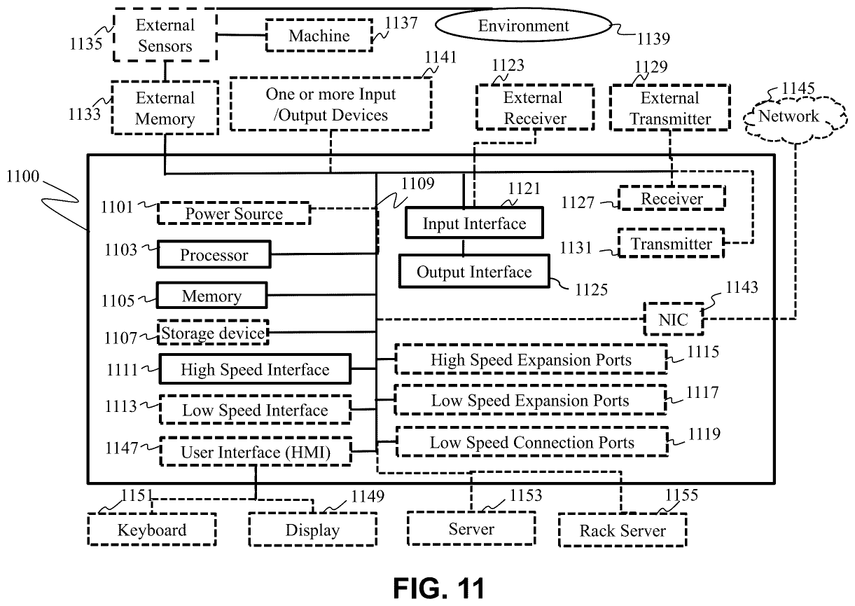

To that end, the non-uniform video encoder system 106 may be implemented using a computing device, as illustrated in FIG. 11.

FIG. 11 is a schematic illustrating a computing device 1100 for implementing the non-uniform video encoder system 106 of the present disclosure. The computing device 1100 includes a power source 1101, a processor 1103, a memory 1105, a storage device 1107, all connected to a bus 1109. Further, a high-speed interface 1111, a low-speed interface 1113, high-speed expansion ports 1115 and low speed connection ports 1117, can be connected to the bus 1109. In addition, a low-speed expansion port 1119 is in connection with the bus 1109. Further, an input interface 1121 can be connected via the bus 1109 to an external receiver 1123 and an output interface 1125. A receiver 1127 can be connected to an external transmitter 1129 and a transmitter 1131 via the bus 1109. Also connected to the bus 1109 can be an external memory 1133, external sensors 1135, machine(s) 1137, and an environment 1139. Further, one or more external input/output devices 1141 can be connected to the bus 1109. A network interface controller (NIC) 1143 can be adapted to connect through the bus 1109 to a network 1145, wherein data or other data, among other things, can be rendered on a third-party display device, third party imaging device, and/or third-party printing device outside of the computing device 1100.

The memory 1105 can store instructions that are executable by the computing device 1100 and any data that can be utilized by the methods and systems of the present disclosure. The memory 1105 can include random access memory (RAM), read only memory (ROM), flash memory, or any other suitable memory systems. The memory 1105 can be a volatile memory unit or units, and/or a non-volatile memory unit or units. The memory 1105 may also be another form of computer-readable medium, such as a magnetic or optical disk.

The storage device 1107 can be adapted to store supplementary data and/or software modules used by the computer device 1100. The storage device 1107 can include a hard drive, an optical drive, a thumb-drive, an array of drives, or any combinations thereof. Further, the storage device 1107 can contain a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, the processor 1103), perform one or more methods, such as those described above.

The computing device 1100 can be linked through the bus 1109, optionally, to a display interface or user Interface (HMI) 1147 adapted to connect the computing device 1100 to a display device 1149 and a keyboard 1151, wherein the display device 1149 can include a computer monitor, camera, television, projector, or mobile device, among others. In some implementations, the computer device 1100 may include a printer interface to connect to a printing device, wherein the printing device can include a liquid inkjet printer, solid ink printer, large-scale commercial printer, thermal printer, UV printer, or dye-sublimation printer, among others.

The high-speed interface 1111 manages bandwidth-intensive operations for the computing device 1100, while the low-speed interface 1113 manages lower bandwidth-intensive operations. Such allocation of functions is an example only. In some implementations, the high-speed interface 1111 can be coupled to the memory 1105, the user interface (HMI) 1149, and to the keyboard 1151 and the display 1149 (e.g., through a graphics processor or accelerator), and to the high-speed expansion ports 1115, which may accept various expansion cards via the bus 1109. In an implementation, the low-speed interface 1113 is coupled to the storage.

Device 1107 and the low-speed expansion ports 1117, via the bus 1109. The low-speed expansion ports 1117, which may include various communication ports (e.g., USB, Bluetooth, Ethernet, wireless Ethernet) may be coupled to the one or more input/output devices 1141. The computing device 1100 may be connected to a server 1153 and a rack server 1155. The computing device 1100 may be implemented in several different forms. For example, the computing device 1100 may be implemented as part of the rack server 1155.

The above-described embodiments of the present disclosure can be implemented in any of numerous ways. For example, the embodiments may be implemented using hardware, software, or a combination thereof. When implemented in software, the software code can be executed on any suitable processor or collection of processors, whether provided on a single computer or distributed among multiple computers. Such processors may be implemented as integrated circuits, with one or more processors in an integrated circuit component. Though, a processor may be implemented using circuitry in any suitable format.

Also, the embodiments of the disclosure may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” in the claims to modify a claim element does not by itself connote any priority, precedence, or order of one claim element over another or the temporal order in which acts of a method are performed but are used merely as labels to distinguish one claim element having a certain name from another element having a same name (but for use of the ordinal term) to distinguish the claim elements.

Although the disclosure has been described by way of examples of preferred embodiments, it is to be understood that various other adaptations and modifications can be made within the spirit and scope of the disclosure.

Therefore, it is the object of the appended claims to cover all such variations and modifications as come within the true spirit and scope of the disclosure.

We claim:

1. A non-uniform video encoder system, comprising: at least one processor; and a memory having instructions stored thereon that, when executed by the at least one processor, cause the non-uniform video encoder system to:
receive a sequence of video frames of a video of a scene;
transform the sequence of video frames into series input data indicative of an evolution of the scene in time, space, or both;
partitioning the series input data into a sequence of non-uniform segments indicative of changes in the evolution of the scene;
encode each segment in the sequence of non-uniform segments by an encoder of an autoencoder architecture with non-uniform unrolling recursion to produce multi-depth encoding of the series input data, wherein, to encode a current segment at a current iteration to produce a current encoding, the non-uniform unrolling recursion combines the current segment with a previous encoding produced at a previous iteration and encodes the combination with the encoder; and
output the multi-depth encoding of the series input data.

2. The non-uniform video encoder system of claim 1, wherein the changes in the evolution of the scene are identified by one or a combination of: an event detected in the scene, a change in a coloration pattern in the scene, a change in captions describing the scene, a change in results of a classification of the scene, an anomaly detected in the scene, an acoustic event detected in the scene, and an event associated with a camera capturing the evolution of the scene with the sequence of the video frames.

3. The non-uniform video encoder system of claim 1, wherein the multi-depth encoding of the series input data forms a spatio-temporal scene graph having nodes representing one or multiple objects in the scene, wherein the current segment for the current iteration includes a portion of the scene graph, wherein the previous encoding produced at the previous iteration forms a super node, and wherein the processor is configured to connect the super node with at least one node in the portion of the scene graph to produce the combination encoded by the encoder at the current iteration.

4. The non-uniform video encoder system of claim 3, wherein the spatio-temporal scene graph includes nodes representing one or multiple static objects and one or multiple dynamic objects in the scene, wherein an appearance and a location of each of the static objects in the scene are represented by properties of a single node of the spatio-temporal scene graph, and wherein each of the dynamic objects in the scene is represented by properties of multiple nodes of the spatio-temporal scene graph describing an appearance, a location, and a motion of each of the dynamic objects at different instances of time.

5. The non-uniform video encoder system of claim 1, wherein the processor is configured to
submit the multi-depth encoding of the series input data to a downstream neural network to perform a task.

6. The non-uniform video encoder system of claim 5, wherein the scene includes an audio scene including speech utterance data having multiple sentences, and wherein the downstream neural network is configured to perform a speech processing task in response to submitting to multi-depth encoding of the series input data of the audio scene to the downstream neural network.

7. The non-uniform video encoder system of claim 1, wherein the processor is configured to
submit the multi-depth encoding of the series input data to a downstream neural network to perform a navigation task.

8. A robot, comprising:
the non-uniform video encoder system of claim 1; and
a navigation system including a neural network configured to generate a navigation command based on the multi-depth encoding of the series input data.

9. The non-uniform video encoder system of claim 8, wherein the scene includes observing objects in a room of a building by the robot moving within the building, and an end of the scene is detected when a robot exits the room.

10. The non-uniform video encoder system of claim 9, wherein the processor is configured to execute a scene decoder configure to generate a navigation plan, the navigation plan including computer-executable instructions that cause the robot to reach a target object in a scene previously encoded by the autoencoder.

11. The non-uniform video encoder system of claim 1, wherein the processor is configured to execute a supernode graph embeddings (SuGE) algorithm to perform the non-uniform unrolling recursion to encode the series input data into a super node corresponding to the multi-depth encoding of the series input data.

12. The non-uniform video encoder system of claim 11, wherein the SuGE algorithm comprises one or more operations, the one or more operations executed by the processor to cause the non-uniform video encoder system to:
obtain local graph data associated with the scene at the current iteration;
obtain global graph data associated with the scene at the previous iteration;
generate a super node for the global graph, in response to the global graph satisfying a graph reduction criterion;
generate updated global graph data based on merging of the local graph data and the generated super node; and
store the updated global graph data as the multi-depth encoding of the series input data in the memory.

13. The non-uniform video encoder system of claim 1, wherein the autoencoder is a graph autoencoder.

14. A controller for controlling a robot to perform a task, comprising:
a memory configured to store instructions; and
a processor configured to execute the stored instructions to carry out steps of a method, comprising:
receiving a sequence of video frames of a video of a scene;
transforming the sequence of video frames into series input data indicative of an evolution of the scene in time, space, or both;
analyzing the series input data to identify changes in the evolution of the scene, by partitioning the series input data into a sequence of non-uniform segments;
encoding each segment in the sequence of non-uniform segments by an encoder of an autoencoder architecture with non-uniform unrolling recursion to produce multi-depth encoding of the series input data, wherein, to encode a current segment at a current iteration to produce a current encoding, the non-uniform unrolling recursion combines the current segment with a previous encoding produced at a previous iteration and encodes the combination with the encoder; and
outputting the multi-depth encoding of the series input data.

15. The controller of claim 14, wherein the changes in the evolution of the scene are identified by one or a combination of: an event detected in the scene, a change in a coloration pattern in the scene, a change in captions describing the scene, a change in results of a classification of the scene, an anomaly detected in the scene, an acoustic event detected in the scene, and an event associated with a camera capturing the evolution of the scene with the sequence of the video frames.

16. The controller of claim 14, wherein the series input data includes a spatio-temporal scene graph having nodes representing one or multiple objects in the scene, wherein the current segment for the current iteration includes a portion of the scene graph, wherein the previous encoding produced at the previous iteration forms a super node, and wherein the processor is configured to connect the super node with at least one node in the portion of the scene graph to produce the combination encoded by the encoder at the current iteration.

17. The controller of claim 16, wherein the spatio-temporal scene graph includes nodes representing one or multiple static objects and one or multiple dynamic objects in the scene, wherein an appearance and a location of each of the static objects in the scene are represented by properties of a single node of the spatio-temporal scene graph, and wherein each of the dynamic objects in the scene is represented by properties of multiple nodes of the spatio-temporal scene graph describing an appearance, a location, and a motion of each of the dynamic objects at different instances of time.

18. The controller of claim 14, wherein the processor is configured to submit the multi-depth encoding of the series input data to a downstream neural network to perform the task.

19. The controller of claim 18, wherein the downstream neural network is configured to generate a navigation command for controlling the robot to perform a navigation task.

20. A non-transitory computer readable storage medium embodied thereon a program executable by a processor for performing a method, the method comprising:
receiving a sequence of video frames of a video of a scene;
transforming the sequence of video frames into series input data indicative of an evolution of the scene in time, space, or both;
analyzing the series input data to identify changes in the evolution of the scene, by partitioning the series input data into a sequence of non-uniform segments;
encoding each segment in the sequence of non-uniform segments by an encoder of an autoencoder architecture with non-uniform unrolling recursion to produce multi-depth encoding of the series input data, wherein, to encode a current segment at a current iteration to produce a current encoding, the non-uniform unrolling recursion combines the current segment with a previous encoding produced at a previous iteration and encodes the combination with the encoder; and
outputting the multi-depth encoding of the series input data.
